(19) United States
(12) Patent Application Publication
(10) Pub. No.: US 2014/0011461 A1
(43) Pub. Date: Jan. 9, 2014

(54) System and Method for Attenuating a Signal in a Radio Frequency System

(71) Applicants: Winfried Bakalski, Muenchen (DE); Andre Dewai, Wickersdorf (DE)

(72) Inventors: Winfried Bakalski, Muenchen (DE); Andre Dewai, Wickersdorf (DE)

(73) Assignee: INFINEON TECHNOLOGIES AG, Neubiberg (DE)

(21) Appl. No.: 13/541,551

(22) Filed: Jul. 3, 2012

(51) Int. Cl. H04B 1/44

(52) U.S. Cl. 455/78

(57) ABSTRACT

In accordance with an embodiment, a method includes coupling power from a transmitter to form a first signal, conditioning the first signal to form a second signal, and coupling the second signal to an input of a receiver. Conditioning includes adjusting the second signal to combine in anti-phase with a leakage signal coupled from the transmitter to the input of the receiver such that the leakage signal is attenuated.

### TECHNICAL FIELD

This invention relates generally to semiconductor circuits and methods, and more particularly to a system and method for attenuating a signal in a radio frequency (RF) system.

### BACKGROUND

The increasing number of frequency bands and standards in mobile communication systems increases the design complexity of mobile phones, as some mobile phones are now configured to operate using multiple standards across multiple frequency bands. In addition, the mobile phone may also include a Global Positioning System (GPS) receiver, an FM radio receiver and a USB port. In many mobile phones, these multiple frequency bands and standards are implemented by using multiple radio frequency (RF) transmitters and receivers within multiple signal paths that may be coupled to a single antenna using an antenna switch and/or to multiple antennas. The introduction of more and more frequency bands within the mobile phone, however, may cause some issues with respect to jamming during operation of the various transmitters and receivers.

For example, a mobile phone employing GSM functionality may transmit an output power of 33 dBm (2 W) when operating in the 824-915 MHz range. If other devices such as an FM radio or a wireless LAN etc. are present, the transmitted RF power from the GSM transmitter may be received by the other receivers within the mobile phone. Even if this power leakage from the GSM transmitter is out of band with respect to the other receivers, variations in filter and antenna matching may allow enough power to leak into an adjoining system. For example, the GSM signal may cause an input LNA of an FM receiver to be pressed into compression, thereby resulting in reduced sensitivity and poor performance. A GSM signal may even be coupled into a USB receiver via a cable connection, causing compression at the input stage of the USB receiver and possibly interrupting a USB data transmission.

Some conventional systems address the issue of transmitter leakage by providing input filters to attenuate strongly interfering RF signals. For example, an FM receiver may use a low-pass filter to suppress signals above 108 MHz, and a USB receiver may use a lossy common mode filter.

### SUMMARY OF THE INVENTION

In accordance with an embodiment, a method includes coupling power from a transmitter to form a first signal, conditioning the first signal to form a second signal, and coupling the second signal to an input of a receiver. Conditioning includes adjusting the second signal to combine in anti-phase with a leakage signal coupled from the transmitter to the input of the receiver such that the leakage signal is attenuated.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates an RF system according to an embodiment of the present invention;

FIG. 2 illustrates an RF system according to a further embodiment;

FIG. 3 illustrates an embodiment RF system having a switchable filter and/or signal block;

FIGS. 4a-b illustrate embodiment RF circuits having an antenna coupling circuit;

FIGS. 5a-d illustrate phase shifter topologies that may be used with embodiment signal conditioning circuits;

FIGS. 6a-d illustrate embodiment adjustable high pass Tee phase shifter circuits;

FIGS. 7a-b illustrate embodiment adjustable low pass PI phase shifter circuits;

FIGS. 8a-c illustrate embodiment resistive Tee attenuator circuits;

FIGS. 9a-c illustrate embodiment resistive PI attenuator circuits; and

FIGS. 10a-d illustrate an embodiment signal conditioning circuit.

Corresponding numerals and symbols in different figures generally refer to corresponding parts unless otherwise indicated. The figures are drawn to clearly illustrate the relevant aspects of the preferred embodiments and are not necessarily drawn to scale. To more clearly illustrate certain embodiments, a letter indicating variations of the same structure, material, or process step may follow a figure number.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, a system for canceling power that leaks from a transmitter to a co-located receiver in an RF system. The invention may also be applied, however, to other types of circuits and systems, such as data transmission systems, communication systems, and other electronic systems.

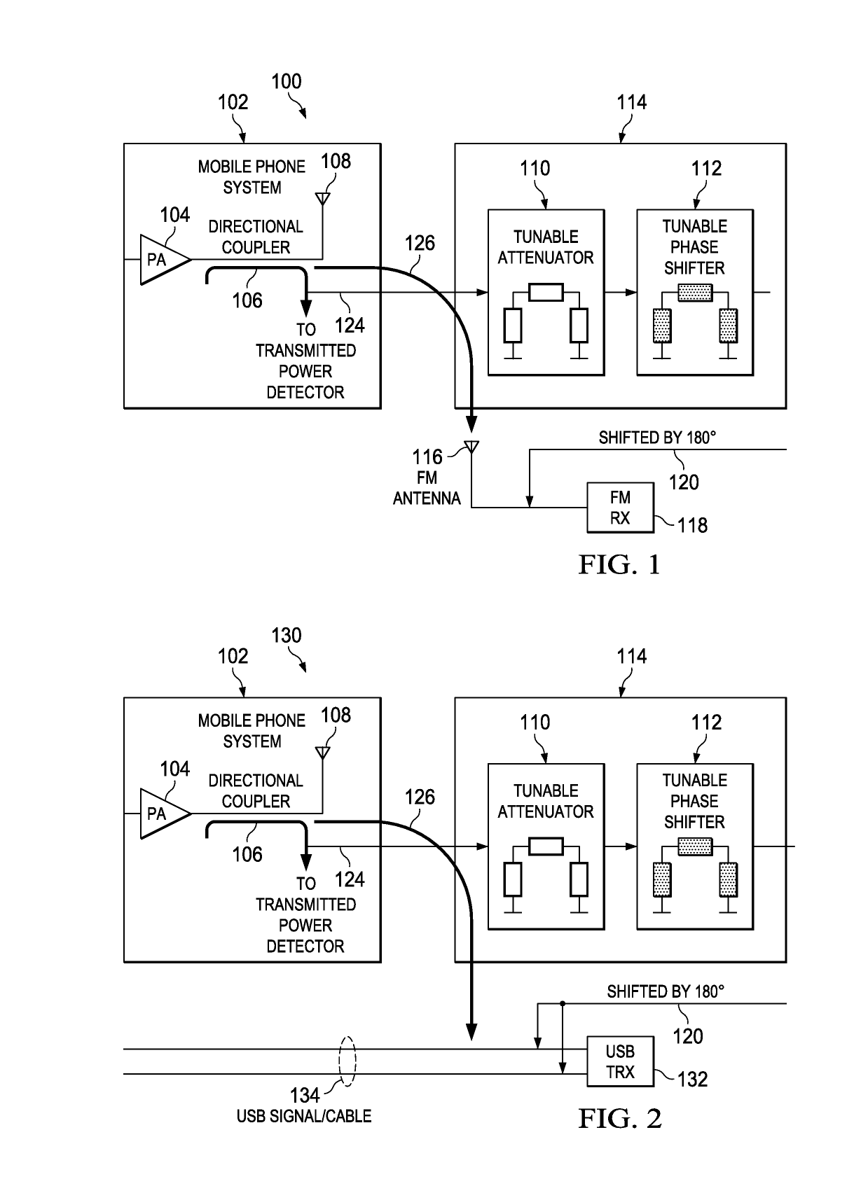

In an embodiment, leakage power from a transmitter to a co-located receiver is attenuated by introducing a canceling signal at the input of the co-located receiver. FIG. 1 illustrates embodiment RF system 100, which has mobile phone system 102 signal conditioning circuit 114 and FM receiver 118. In an embodiment, RF system 100 is situated within a mobile phone or mobile handset. In alternative embodiments of the present invention are system 100 may represent, for example, a radio disposed within a computer, a tablet computer, a multimedia device, or other electronic system that has multiple RF systems within the same chassis or co-located within a short distance of each other.

Mobile phone system 102 may be an RF system that is configured to operate according to a mobile phone system standard such as GSM, CDMA, LTE or others communication system standards. In an embodiment, mobile phone system 102 contains power amplifier 104 coupled to antenna 108. It should be understood that system 102 may contain other components such as an upconverter, a baseband processor, and other circuitry used to enable communications with a base station, which are not shown in FIG. 1 for simplicity of illustration. During operation, power output by power amplifier 104 is transmitted over antenna 108. Some of this transmitted power may couple into FM receiver 118 via FM antenna 116. This coupling is represented in FIG. 1 by arrow 126. It should be understood that power may also couple from the outside of power amplifier 104 into the input of FM receiver 118 through other parasitic signal paths, for example, coupling within a circuit board that houses system 100, such as magnetic coupling between lines, capacitive coupling between board traces, and coupling via the power supply. The aggregate sum of these parasitic coupling paths may interfere with the reception of FM receiver 118 and/or desensitize the front end of FM receiver 118.

In an embodiment, the effects of coupling between power transmitted from mobile phone system 102 to FM receiver 118 may be reduced by introducing canceling signal 120. In an embodiment, canceling signal 120 is produced by signal conditioning circuit 114, which produces a signal of approximately the same amplitude and the opposite phase of the leaked transmit signal of mobile phone system 102 as seen by the input of receiver 118.

In an embodiment, power is coupled from the output of power amplifier 104 via directional coupler 106 to form first coupled signal 124. Directional coupler 106 takes a small portion of the signal output by power amplifier 104, for example −20 dB. In some embodiments, this coupled output power may also be used by a transmitted power detector utilized by mobile phone system 102. This transmitted power detector may be implemented, for example, by a rectifying diode or other power detection circuit known in the art. Signal conditioning circuit 114 attenuates first coupled signal 124 via tunable attenuator 110, and shifts the phase via tunable phase shifter 112 to form cancellation signal 120. In some embodiments, cancellation signal 120 is shifted about 180° with respect to first coupled signal 124 to form an anti-phase signal. In other embodiments, cancellation signal 120 may be shifted by some other phase besides 180° in order to compensate for phase shifts within leakage path 126. Cancellation signal 120 is summed to the signal received by FM antenna 116 at the input to FM receiver 118. By summing the signal that is about the same amplitude and about 180° out of phase with leakage signal 126, the effect of leakage signal 126 may be significantly attenuated.

In some embodiments, tunable attenuator 110 and tunable phase shifter 112 may be lossy, for example, having a composite attenuation of greater than 20 dB. As such, tunable phase shifter 112 may be lossy and may be combined in series with tunable attenuator 110.

It should be understood that the system shown in FIG. 1 is just one example of a specific embodiment. Embodiments of the present invention may be further used to compensate for the effects of different types of transmitting systems leaking into receivers of different types of reception systems. Even though FIG. 1 depicts receiver 118 as an FM receiver, in alternative embodiments of the present invention, receiver 118 may be a GPS receiver, a Wi-Fi receiver, a further mobile phone system receiver, or other type of receiver. Likewise, mobile phone system 102 that generates leakage power 126 may be any type of transmitter, for example, a Wi-Fi transmitter, or a mobile phone system of various standards, such as GSM, CDMA, LTE, WiMAX, and the like.

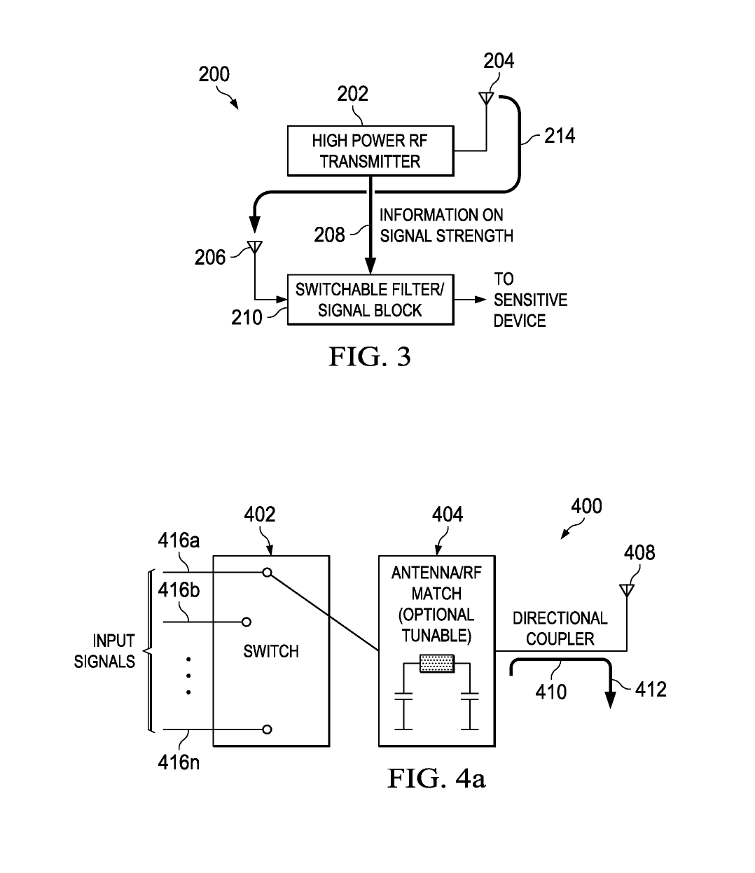

FIG. 2 illustrates RF system 130 according to a further embodiment of the present invention. Mobile phone system 102 and signal conditioning circuit 114 is similar in operation to mobile phone system 102 depicted in FIG. 1. Here, however, compensation signal 120 is added to a common mode input of USB system 132, in order to compensate for the effects of leakage signal 126 coupling onto USB signal cable 134. By providing compensation signal 120 that is about 180° out of phase with coupled transmit signal 126, large disturbances, which may potentially degrade the performance of USB transceiver 132, may be compensated.

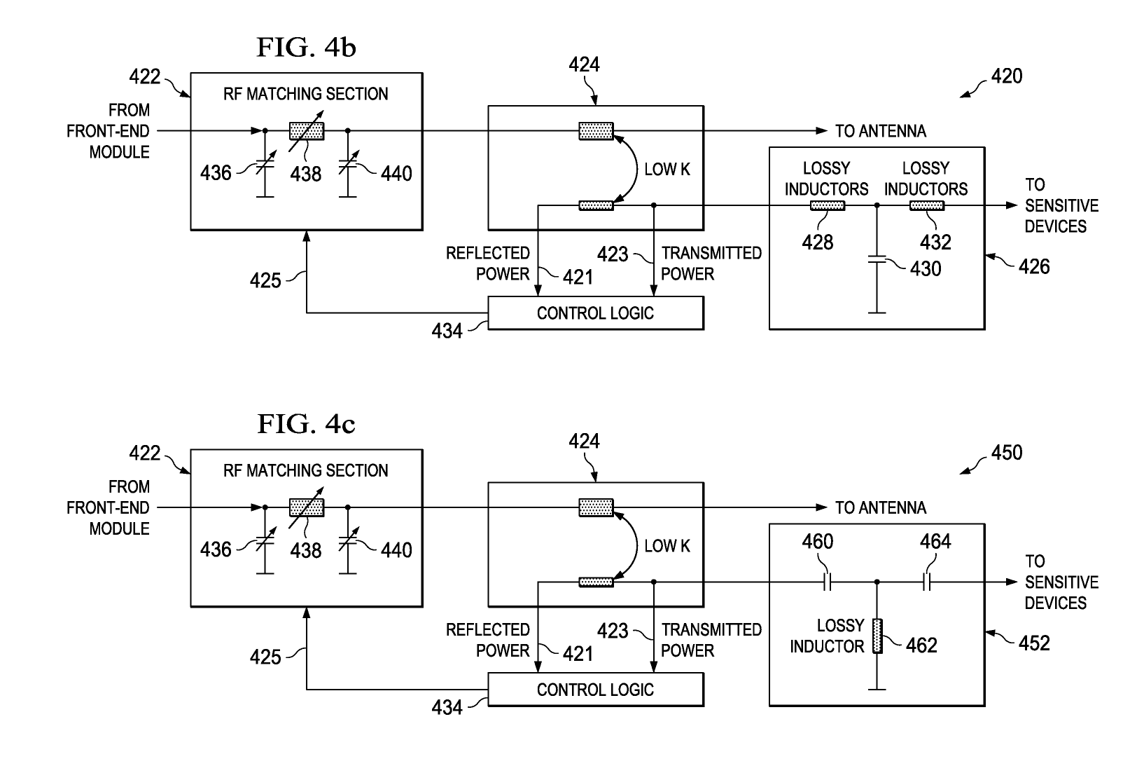

FIG. 3 illustrates system 200 according to another embodiment of the present invention. In an embodiment, RF transmitter 202 transmits signals via antenna 204. Portion 214 of this transmitted signal may be coupled into switchable filter signal block 210, the input of which is represented as antenna 206. Switchable filter signal block 210 may include a filter that may be enabled or disabled according to signal strength information provided by RF transmitter 202. In an embodiment, the switchable filter within signal block 210 is activated during the time that RF transmitter 202 is transmitting and/or during the time that the RF power transmitted by transmitter 202 exceeds a threshold.

In an embodiment, switchable filter/signal block 210 may be applied to the input of a USB circuit. For example, in one embodiment, a common mode filter of a USB port may be switched in and out depending on the power transmitted by RF transmitter 202 as represented by signal strength information signal 208. Alternatively, switchable filter/signal block 210 may contain a switch that disables the input signal path of a USB port. For example, during times that RF transmitter 202 is transmitting and/or during times that the output power of RF transmitter 202 exceeds a particular threshold, the input to a USB transceiver (such as USB transceiver 132 illustrated in FIG. 2) may be disabled. By disabling the input to USB transceiver instead of allowing the performance of the USB transceiver to degrade due to coupled signals, performance may be improved by avoiding the generation of further distortion generated in the USB transceiver input due to high signal levels. In embodiments where RF transmitter 202 is a GSM transmitter, the USB connection may be shut down during the time during which a 577 μs short GSM burst is transmitted.

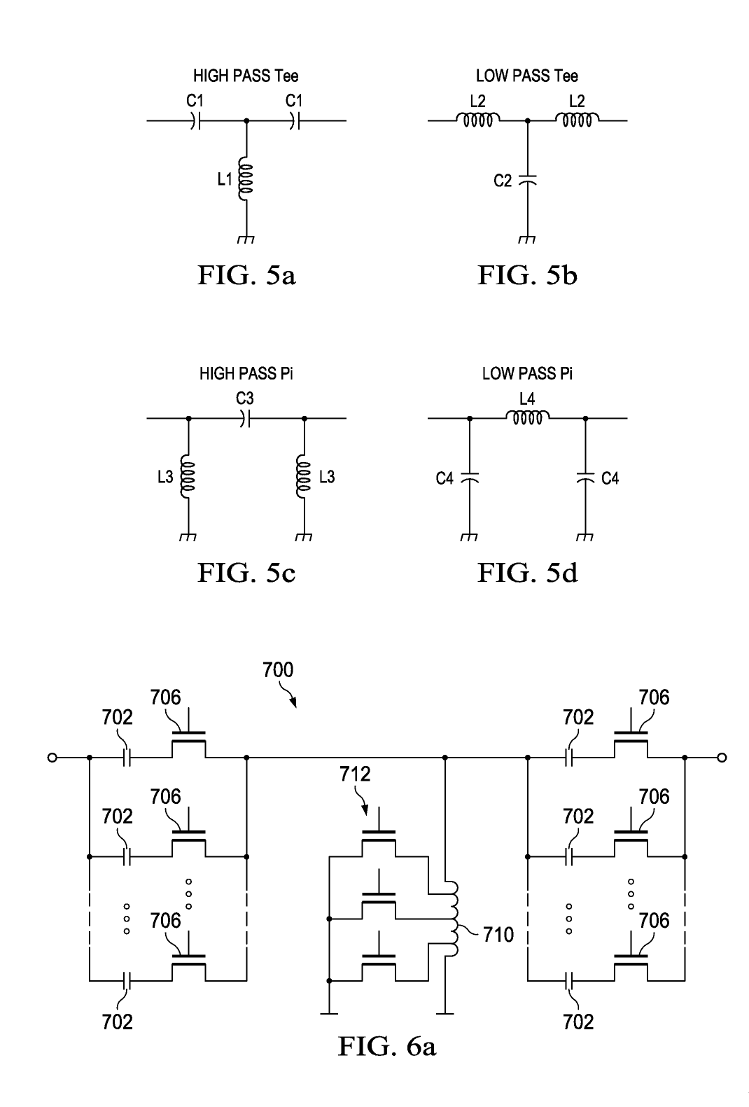

FIG. 4a illustrates embodiment RF transmission path 400 having a plurality of transceivers that may be used in a RF circuit such as a multi-standard mobile phone. RF transmission path 400 has antenna switch 402 that is coupled to transmitter output signals 416a to 416n, which may be coupled to various types of RF transmitters. Antenna matching network 404 is coupled to the output of switch 402. In some embodiments, antenna matching network 404 may be tunable, for example, in embodiments in which various RF transmitters coupled to transmitter output signals 416a to 416n operate at different frequencies and/or bandwidths. Directional coupler 410 is coupled between antenna matching network 404 and antenna 408. Output 412 of directional coupler 410 may be used by embodiment signal conditioning circuits in order to produce a compensating signal. RF transmission path 400 is particularly well suited for multi-standard mobile phones that share a single antenna.

FIG. 4b illustrates RF transmission path 420 having tunable RF matching section 422 and directional coupler 424 that is configured to be coupled to an antenna. RF matching section 422 may be coupled, for example, to the output of a power amplifier, to an output of an RF switch, or to other circuits. Directional coupler 424 may be used to derive a figure of merit with respect to the quality of the antenna match. For example, control logic 434 may compare a couple transmitted power from directional coupler 424 with a coupled reflected power 421 to derive control signal 425. Control signal 425 may be further used to tune RF matching section 422. In an embodiment, RF matching section 422 includes a PI network having adjustable capacitors 436 and 440 and adjustable inductor 438. Control signal 425 may adjust parameters of RF matching section 422 until a ratio of reflected power to transmitted power is minimized. It should be appreciated that the structure of RF matching section 422 is shown as an example. In alternative embodiments of the present invention, RF matching section 422 may be implemented using different matching topologies.

In an embodiment, transmitted power signal 423 may also be used as an input to signal conditioning circuit 426, which may be configured to provide an embodiment cancellation signal. In an embodiment, signal conditioning circuit 426 is implemented using a Tee network including lossy inductors 428 and 432, as well as shunt capacitor 430. By using lossy inductors 428 and 432, signal conditioning circuit 426 may achieve both an attenuation and phase shift that cancels the effect of transmit power coupled onto other receivers present in the system. In an embodiment, these lossy inductors and/or the shunt capacitor may be tunable. It should be further appreciated that by using transmitted power signal 423 as an input to signal conditioning circuit 426, pre-existing directional coupler 424 may be used, thereby reducing the number of components necessary to implement embodiment signal cancellation schemes.

FIG. 4c illustrates further embodiment RF signal path 450 that is similar to RF signal path 420 illustrated in FIG. 4b, with the exception of signal conditioning circuit 452 coupled to transmitted power signal 423 output from directional coupler 424. In an embodiment, signal conditioning circuit 452 is implemented using a Tee network including a single lossy inductor 462, and two series capacitors 460 and 464. In alternative embodiments of the present invention, other network topologies may be used to implement signal conditioning circuit 452.

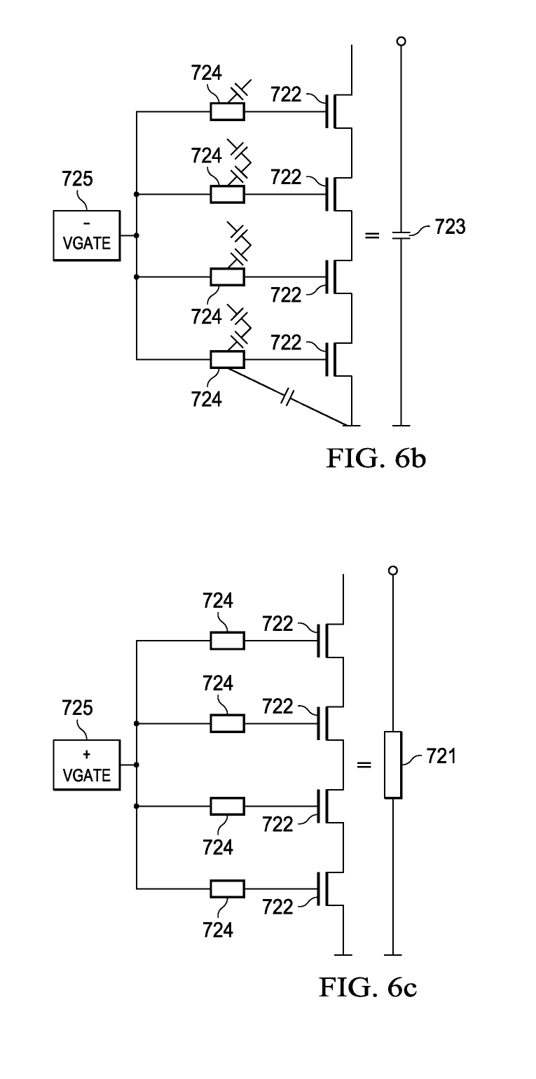

FIGS. 5a-d illustrate some networks that may be used to implement embodiment phase shifter networks. In some embodiments, the circuit elements shown in FIGS. 5a-d may be adjustable. FIG. 5a illustrates a high pass Tee network having series capacitors C1 and shunt inductor L1. In order to implement a phase shift of φ, inductor L1 and capacitors C1 may be selected according to the following equations:

$$L 1 = \frac{{Z}_{0}}{ω sin ( φ )}$$

$$C 1 = \frac{sin ( φ )}{ω {Z}_{0} ( 1 - cos ( φ ) )} ,$$

where ω is the natural frequency, and Z₀ is the characteristic impedance. In some embodiments, Z₀ may be, for example, about 50Ω. Alternatively, other characteristic impedances may be used.

FIG. 5b illustrates a low pass Tee network having series inductors L2 and shunt capacitor C2. In order to implement a phase shift of φ, inductors L2 and capacitor C2 may be selected according to the following equations:

$$L 2 = \frac{{Z}_{0} ( 1 - cos ( φ ) )}{ω sin ( φ )}$$

$$C 2 = \frac{sin ( φ )}{ω {Z}_{0}} .$$

FIG. 5c illustrates a high pass Pi network having series capacitor C3 and shunt inductors L3. In order to implement a phase shift of φ, capacitor C3 and inductor L4 may be selected according to the following equations:

$$L 3 = \frac{{Z}_{0} sin ( φ )}{ω ( 1 - cos ( φ ) )}$$

$$C 3 = \frac{1}{ω {Z}_{0} sin ( φ )} .$$

FIG. 5d illustrates a low pass Pi network having series inductor L4 and shunt capacitors C4. In order to implement a phase shift of φ, inductor L4 and capacitors C4 may be selected according to the following equations:

$$L 4 = \frac{{Z}_{0} sin ( φ )}{ω}$$

$$C 4 = \frac{1 - cos ( φ )}{ω {Z}_{0} sin ( φ )} .$$

In alternative embodiments, other phase shifter structures known in the art may be used besides the circuits shown in FIGS. 5a-d.

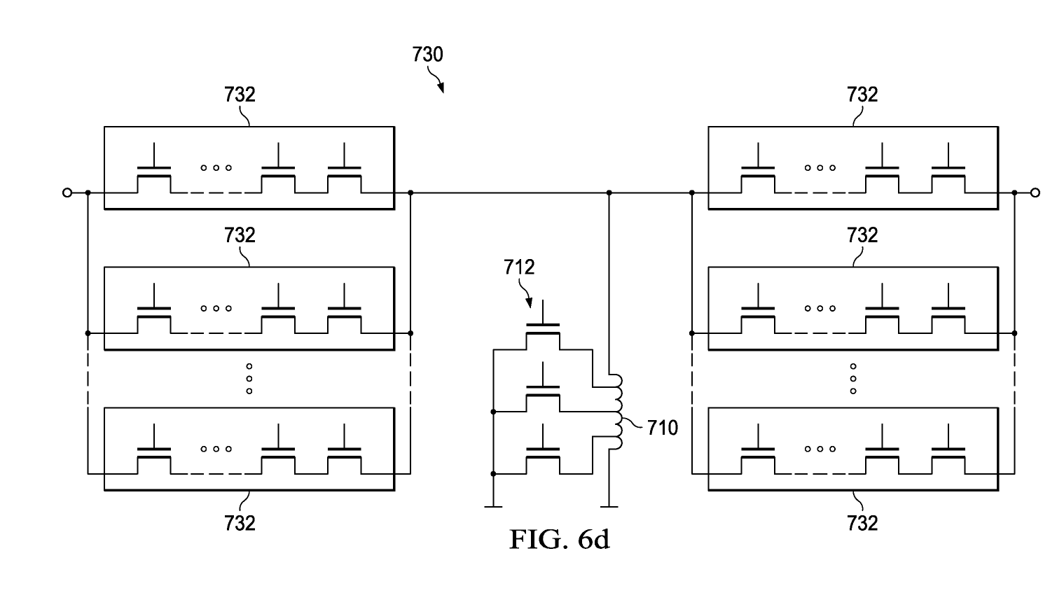

FIGS. 6a-d and 7a-b illustrate various embodiment circuits that implement a tunable phase shifter. For example, FIG. 6a illustrates phase shifter 700 implemented as a tunable high pass Tee network having a plurality of switchable series capacitors 702 that may be switched in and out of the phase shifter using switches 706. Moreover, the inductance of shunt inductor 710 may be adjusted by activating or deactivating transistors 712 coupled onto various tap points within inductor 710. While FIG. 6a, only shows three parallel devices for series capacitors 702 and only three inductor tap transistors 712 coupled to inductor 710, any number of branches may be implemented depending on the particular system and its specifications. It should be further noted that any number of parallel branches may be used to implement phase shifter and attenuation circuits in the other embodiments presented herein. Transistors 706 and 712 may be implemented using MOS devices, GaAs pHEMT, or MEMs devices, or other devices depending on the particular technology being used to implement the phase shifter. In an embodiment, phase shifter 700 may be further implemented on an integrated circuit, and/or as one or more discrete components on a circuit board. For example, phase shifter 700 may be implemented in LTCC modules, as GaAs pHEMT devices, or in a CMOS technology. The inductor may be realized as planar coil. Capacitors may be implemented as MIM metal-insulator-metal (MIM) capacitors or as MOSCAPs, which have more losses and a lower Q factor than MIM capacitors.

In some cases, tunable phase shifter capacitors may be implemented using accumulation mode MOS devices. For example, FIG. 6b illustrates series NMOS devices 722 that are biased by gate voltage 725 via resistors 724. By biasing NMOS devices 722 below the threshold of the devices, the series combination of devices 722 may be used to implement capacitor 723. Here, the capacitance of capacitor 723 is made up of a series combination of gate drain and gate source capacitances of NMOS devices 722. Resistors 724 have high-ohmic resistance values between about 10 kΩ and about 400 kΩ to ensure that the impedance seen by the gates of NMOS devices 724 is high enough that the capacitances of devices 722 are dominant at the phase shifting frequency. In some embodiments, the capacitance of capacitor 723 may be adjusted by controlling negative gate voltage 725. In other embodiments, gate voltage 725 may be constant. Alternatively, capacitance 723 may be switched in or out of the phase shifter circuit.

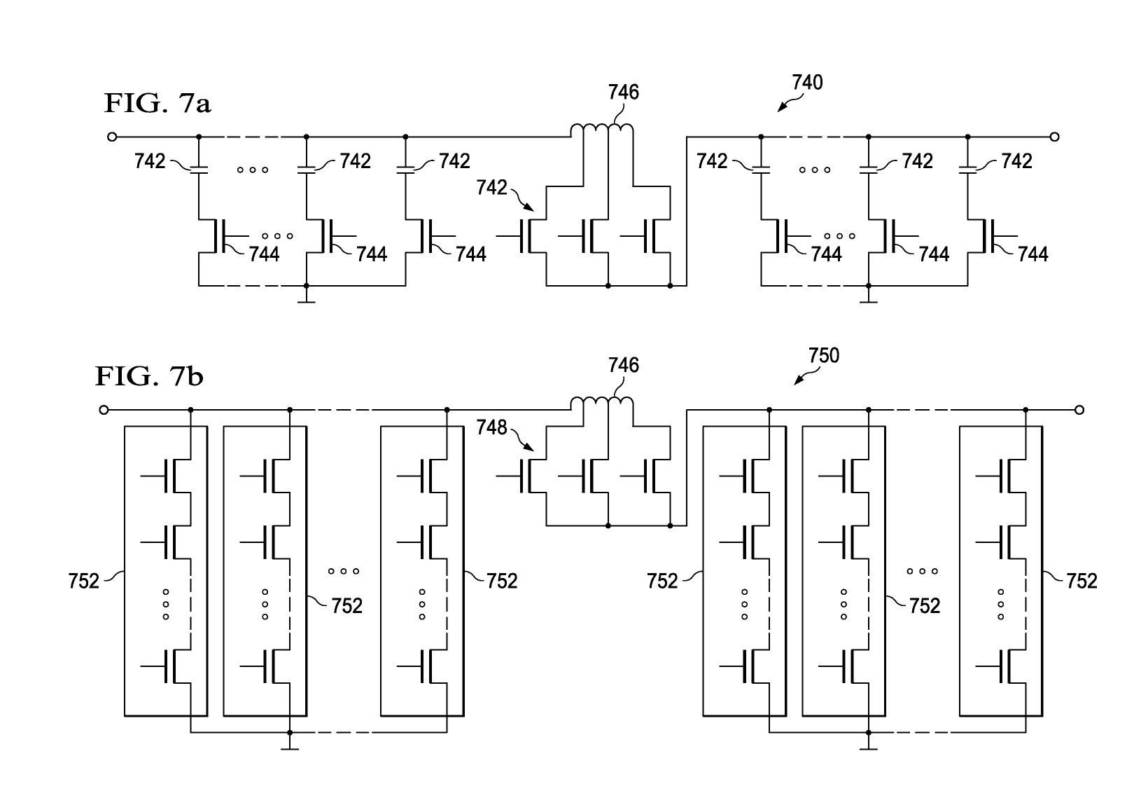

When NMOS devices 722 are driven by a gate voltage that is above their threshold such that NMOS devices operate in the linear region, resistance 721 may be implemented, as is diagrammatically illustrated in FIG. 7c. In some embodiments, the controllable resistances used in attenuators may be implemented using the circuit of FIG. 6c.

FIG. 6d illustrates phase shifter 730 implemented using an adjustable high pass Tee configuration having series NMOS device branches 732 biased as accumulation mode capacitors. A shunt inductance is implemented using inductor 710 that is adjustable via transistors 712. In an embodiment, the series capacitances of phase shifter 730 may be adjusted by varying the gate voltage of devices within device branches 732, and/or by switching various NMOS device branches in and out of phase shifter 730.

FIG. 7a illustrates phase shifter 740 implemented as a tunable low pass PI network having a plurality of switchable series capacitors 742 that may be switched in and out of the phase shifter using switching transistors 744. Moreover, the inductance of series inductor 746 may be adjusted by activating or deactivating transistors 742 coupled onto various tap points within inductor 746.

FIG. 7b illustrates phase shifter 750 that is implemented using an adjustable low pass PI configuration having series NMOS device branches 752 biased as accumulation mode capacitors. A series inductance is implemented using inductor 746 that is adjustable via transistors 748. In an embodiment, the shunt capacitances of phase shifter 750 may be adjusted by varying the gate voltage of devices within device branches 752, and/or by switching various NMOS device branches in and out of phase shifter 750. While adjustable versions of a high pass Tee network and a low pass PI network have been described herein, it should be understood that adjustable versions of a high pass PI network and a low pass Tee network may be similarly constructed using the concepts described with respect to FIGS. 6a-d and 7a-b. However, single inductor implementations of the high pass Tee network and the low pass PI network may be more area efficient than the high pass PI network and a low pass Tee network, since only a single inductor, rather than two inductors, is implemented.

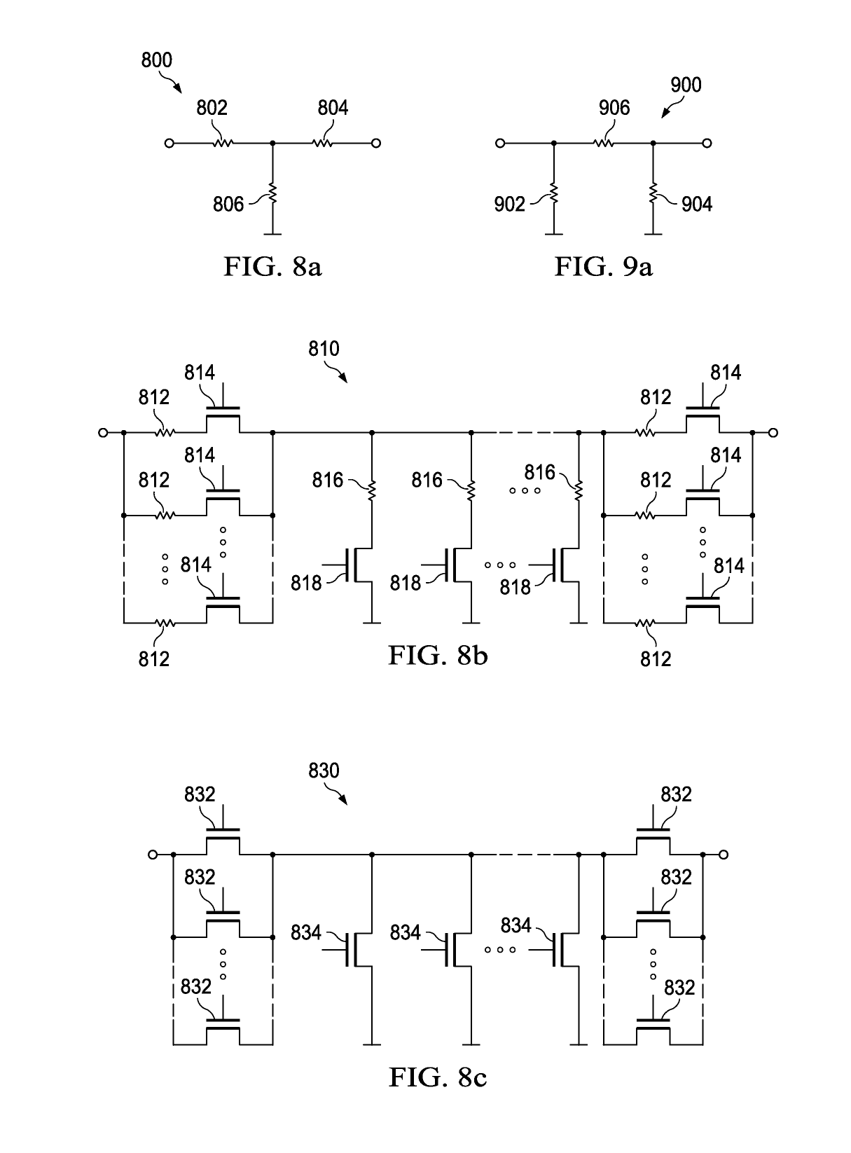

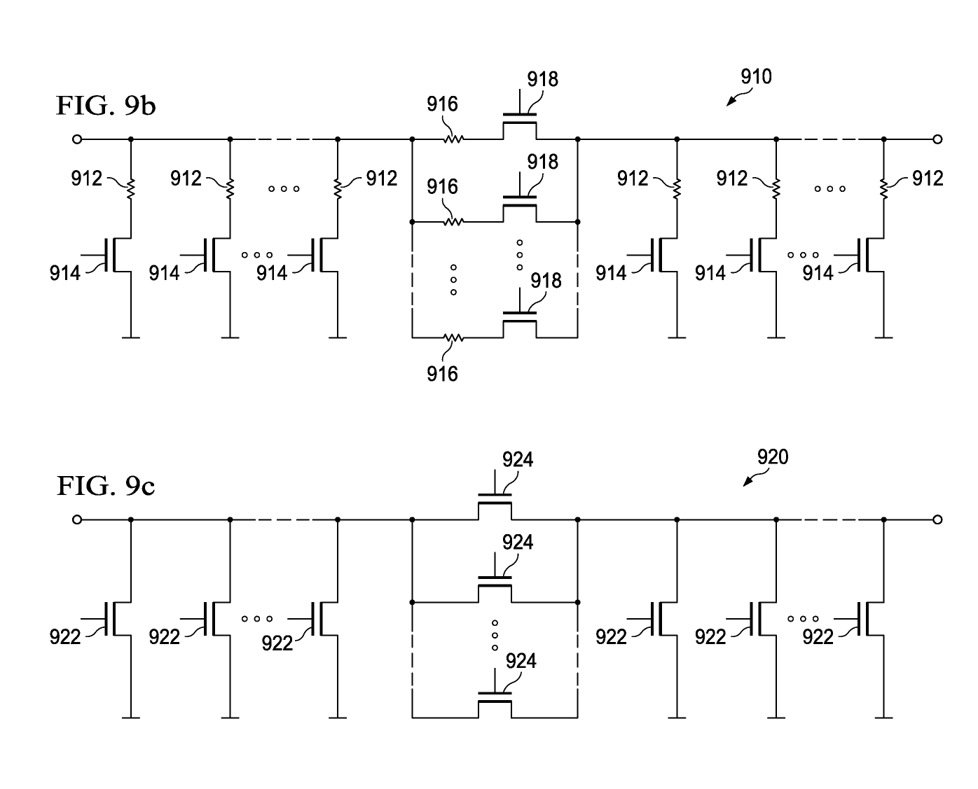

In embodiments of the present invention, attenuators used in signal conditioning circuits described herein may be implemented using a number of different networks. Two of such networks that may be used are the resistive Tee attenuator shown in FIG. 8a and the resistive PI attenuator shown in FIG. 9a. Alternatively, other attenuator structures known in the art may also be used.

FIG. 8a illustrates resistive Tee attenuator 800 having series resistor's 802 and 804, and shunt resistor 806. The resistances of resistors 802, 804 and 806 may be selected using techniques known in the art to achieve an attenuation value that provides signal cancellation when combined with a suitable phase shift. FIG. 8b illustrates an adjustable resistive Tee attenuator 810 implemented using a parallel combination of series resistors 812 that may be switched in and out of the attenuator using switches 814. Similarly, shunt resistors 816 may be switched in and out of the network using switches 818. Resistors 812 and switches 814 may be implemented on an integrated circuit using, for example, available resistance structures, such as polysilicon resistors and diffusion resistors, and switching transistors such as NMOS and/or PMOS transistors. In alternative embodiments of the present invention, resistors 812 and 816, and switching transistors 814 and 818 may be implemented using other device types.

FIG. 8c illustrates adjustable resistive Tee attenuator 830 implemented according to an alternative embodiment. Here, the series resistors in the attenuator are implemented using MOS transistor devices 832, and the shunt resistors in the attenuator are implemented using MOS transistor devices 834. The gate voltages of MOS transistor devices 832 and 834 may be controlled using techniques known in the art to achieve a particular attenuation and/or to control the attenuation of attenuator 830. In an embodiment, MOS transistors 832 and 834 may be biased in the linear region. As such, devices 832 and 834 may be implemented using devices having a small width and a long length in order to ensure sufficient resistance and that the devices remain in the linear region during operation.

FIG. 9a illustrates resistive PI attenuator 900 having shunt resistors 902 and 904, and series resistor 906. As with the embodiment of FIG. 8a, the resistances of resistors 902, 904 and 906 may also be selected using techniques known in the art to achieve an attenuation value that provides signal cancellation when combined with a suitable phase shift. FIG. 9b illustrates an adjustable resistive PI attenuator 910 implemented using a parallel combination of shunt resistors 912 that may be switched in and out of the attenuator using switches 914. Similarly, series resistors 916 may be switched in and out of the network using switches 918. In an embodiment, resistors 912 and 916 and switches 914 and 918 may be implemented similarly as described with respect to the embodiment of FIG. 8b.

FIG. 9c illustrates adjustable resistive PI attenuator 920 implemented according to an alternative embodiment. Here, a parallel combination of shunt resistors 912 may be switched in and out of the attenuator using switches 914. Similarly, series resistors 916 may be switched in and out of the network using switches 918. In an embodiment, resistors 912 and 916 and switches 914 and 918 may be implemented similarly as described with respect to the embodiment of FIG. 8b.

FIG. 9c illustrates adjustable resistive PI attenuator 920 implemented according to an alternative embodiment. Here, the shunt resistors in the attenuator are implemented using MOS transistor devices 922, and the series resistors in the attenuator are implemented using MOS transistor devices 924. In an embodiment, MOS devices 922 and 924 may be controlled as described with respect to the embodiment shown in FIG. 8c.

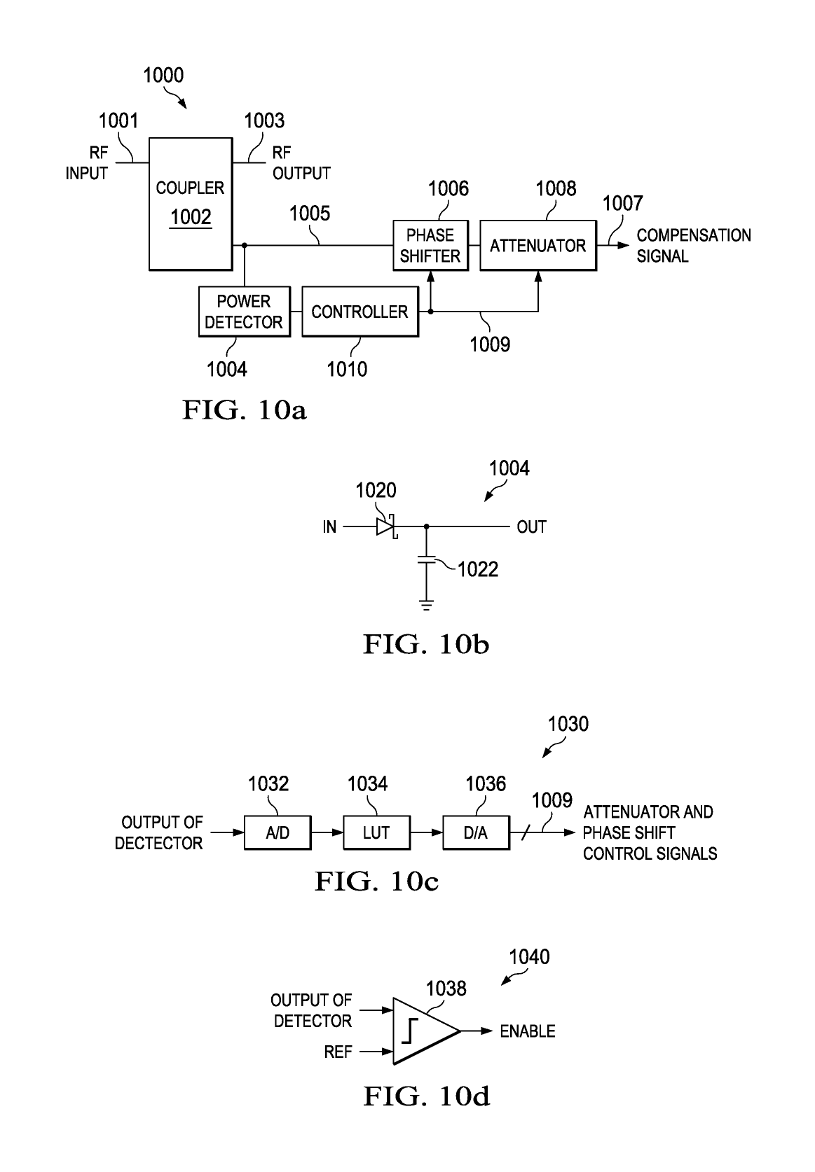

FIG. 10a illustrates compensation circuit 1000 according to a further embodiment of the present invention. Compensation circuit 1000 includes coupler 1002 that is configured to be coupled to RF input 1001 and produce RF output 1003. In an embodiment, RF input 1001 may be output from the power amplifier and/or an antenna matching circuit, and RF output 1003 may be coupled, for example, to an antenna. Coupler 1002, which may be implemented using a directional coupler, also produces coupled power output 1005 coupled to the input of phase shifter 1006 and attenuator 1008 to produce compensation signal 1007. Compensation signal 1007 may be used to compensate for a transmitted leakage signal by being coupled to an input of a receiver as described in embodiments herein. Power detector 1004 is coupled to power output 1005, and may be used to control the phase shift of phase shifter 1006 and the attenuation of attenuator 1008. In some embodiments, power detector 1004 may also be used to enable or disable phase shifter 1006 and attenuator 1008, or enable or disable compensation signal 1007. In some embodiments, controller 1010 may be used to transform the output of power detector 1004 into control signals 1009.

Turning to FIG. 10b, an example embodiment of power detector 1004 is shown. In an embodiment, Schottky diode 1020 is coupled to capacitor 1022. The coupled signal may be applied to the anode of Schottky diode, which produces a rectified signal at node OUT. It should be appreciated that the embodiment of power detector 1004 shown in FIG. 10b is just one example of many possible power detector circuits. In alternative embodiments of the present invention, other diode types and other devices, such as the base-emitter diode of a bipolar transistor, may be used for power detector 1004 and/or other power detection circuits known in the art may be used.

FIG. 10c illustrates embodiment controller circuit 1030 that may be used to provide control signals 1009 that controls a phase shifter and an attenuator. In an embodiment, control circuit 1030 performs and A/D conversion of the output of detector 1004 using A/D converter 1032, and provides the output of A/D converter 1032 to lookup table 1034. The output of lookup table 1034 may be converted back to the analog domain using D/A converter 1036. In some embodiments of the present invention, D/A converter 1036 may be omitted if the phase shifter and/or the attenuator are digitally controllable. Moreover, entries in lookup table 1034 may be programmed using embodiment calibration methods described herein. A/D converter 1032, lookup table 1034, and D/A converter 1036 may be implemented using circuits and methods known in the art.

In an embodiment, the system may be tuned or calibrated by measuring a defined signal at the transmitter and detecting the signal at one or more receiver inputs. The phase and amplitude of the compensation signal is changed via phase shifter 1006 and attenuator 1008 (FIG. 10) until the detected signal at the one or more receiver inputs is below a threshold. Attenuator and phase shifter control parameters, such as the D/A code that generates control signal 1009, is stored in a memory, such as lookup table 1034.

FIG. 10d illustrates controller circuit 1040 according to a further embodiment of the present invention. In an embodiment, the output of power detector 1004 is compared with reference voltage REF using comparator 1038 to provide an enable signal. This enable signal may be used to enable or disable the compensation signal path. In some embodiments, this enable signal may be used to enable or disable the target receiver. For example, in an embodiment in which the target receiver is a USB port, the enable signal may be used to enable the USB port when the detected power output is below a threshold defined by voltage REF.

In accordance with an embodiment, a method includes coupling power from a transmitter to form a first signal, conditioning the first signal to form a second signal, and coupling the second signal to an input of a receiver. Conditioning includes adjusting the second signal to combine in anti-phase with a leakage signal coupled from the transmitter to the input of the receiver such that the leakage signal is attenuated. In an embodiment, conditioning may further include attenuating and phase shifting the first signal. Furthermore, coupling may include coupling the first signal from an antenna port of the transmitter.

In an embodiment, the method further includes determining a signal strength of the power from the transmitter, comparing the determined signal strength to a threshold, and coupling the second signal to an input of a receiver only when the determined signal strength exceeds the threshold.

In some embodiments, conditioning further includes performing a calibration by transmitting a defined signal, detecting a leakage of the defined signal at the input of the receiver, and adjusting a phase and amplitude of the second signal until the detected leakage is canceled. Adjusting the phase and amplitude of the second signal may include adjusting the phase and amplitude of the second signal until the detected leakage is attenuated below a second threshold. Performing the calibration may further include storing amplitude and phase data associated with the adjusted phase and amplitude of the second signal in a memory.

In an embodiment, conditioning the first signal further includes retrieving the amplitude and phase data from the memory and applying the adjusted amplitude and phase associated with the retrieved amplitude and phase data to the first signal to form the second signal. In some embodiments, the method may include coupling the second signal to a second receiver.

In an embodiment, a system for attenuating leakage power from a transmitter to a receiver includes a first input port configured to be coupled to the transmitter, and a signal conditioning circuit. The signal conditioning circuit includes an input port configured to be coupled to the transmitter, and an output port configured to be coupled to an input of the receiver. The signal conditioning circuit may be configured to produce an anti-phase signal at the output port that attenuates a leakage signal coupled from the transmitter to the input of the receiver.

In an embodiment, the system further includes a directional coupler coupled to an antenna port of the transmitter, wherein the directional coupler has an output port coupled to the first input port. The signal conditioning circuit may be configured to adjust an amplitude and phase of a transmitter signal coupled to the first input port.

In an embodiment, the signal conditioning circuit includes a tunable attenuator and a tunable phase shifter. The tunable attenuator may include an adjustable resistor network that may be implemented using a PI network or a T network having resistors coupled in series with semiconductor switches. The tunable phase shifter may be implemented using a PI network or a T network having an adjustable capacitor and an adjustable inductor. The adjustable capacitor may be an accumulation mode MOSFET capacitor.

In accordance with a further embodiment, a radio frequency circuit includes a transmitter configured to provide a transmission signal for a first system, a first receiver configured to operate with a second system, and a conditioning circuit coupled between the transmitter and the first receiver. The conditioning circuit may be configured to attenuate a leakage signal transmitted from the transmitter to the first receiver by producing an anti-phase signal and summing the anti-phase signal at an input of the first receiver.

In an embodiment, the conditioning circuit includes an adjustable attenuator and an adjustable phase shifter. The adjustable attenuator may include a resistive PI network or a resistive T network, and the adjustable phase shifter may include a LC PI network or a LC Tee network. Alternatively, the adjustable attenuator may include a plurality of switchable resistors, and the adjustable phase shifter may include a plurality of adjustable capacitors.

In an embodiment, the conditioning circuit further includes a directional coupler configured to be coupled to the transmitter. This directional coupler may be coupled to an antenna port of the transmitter. The conditioning circuit may also include a power detector coupled to a comparator, and may be configured to sum the anti-phase signal at the input of the first receiver only when the comparator indicates that an output of the power detector exceeds a comparator threshold.

In an embodiment, the radio frequency circuit also includes a second receiver coupled to the first receiver, and the conditioning circuit is further configured to attenuate a further leakage signal transmitted from the transmitter to the second receiver by producing a further anti-phase signal and summing the further anti-phase signal at an input of the second receiver. In some embodiments, the transmitter is configured to transmit a GSM signal, the first receiver is configured to receive a FM signal, and the second receiver is configured to receive a USB signal. Accordingly, the transmitter and the first receiver may be disposed on a mobile phone.

An advantage of embodiments of the present invention includes the ability to prevent an adjoining transmitter from interfering with an input to a receiver without requiring complex filtering and/or extensive attenuation that may reduce the sensitivity of the receiver.

A further advantage is that, in some cases, a single embodiment compensation circuit may be used for compensate for a leakage signal that coupled to various different receivers having different input types. For example, in a USB port, the distorter may be common mode signal. Since a USB input port accepts a differential signal, the leakage signal may not have a large effect on the differential input signal, but a strong interference signal may saturate the input of the USB receiver. In such a case, each differential input pin of the USB port may be coupled to an embodiment compensation signal. On the other hand, for an FM receiver, the compensation signal may be coupled to a single ended RF input.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method comprising:
coupling power from a transmitter to form a first signal;
conditioning the first signal to form a second signal; and
coupling the second signal to an input of a receiver, wherein conditioning comprises adjusting the second signal to combine in anti-phase with a leakage signal coupled from the transmitter to the input of the receiver such that the leakage signal is attenuated.

2. The method of claim 1, wherein conditioning further comprises attenuating and phase shifting the first signal.

3. The method of claim 1, wherein coupling comprises coupling the first signal from an antenna port of the transmitter.

4. The method of claim 1, wherein:
the method further comprises determining a signal strength of the power from the transmitter;
comparing the determined signal strength to a threshold; and
coupling the second signal to an input of a receiver only when the determined signal strength exceeds the threshold.

5. The method of claim 1, wherein conditioning further comprises performing a calibration, performing a calibration comprising:
transmitting a defined signal;
detecting a leakage of the defined signal at the input of the receiver; and
adjusting a phase and amplitude of the second signal until the detected leakage is canceled.

6. The method of claim 5, wherein adjusting the phase and amplitude of the second signal comprises adjusting the phase and amplitude of the second signal until the detected leakage is attenuated below a second threshold.

7. The method of claim 5, wherein performing the calibration further comprises storing amplitude and phase data associated with the adjusted phase and amplitude of the second signal in a memory.

8. The method of claim 7, wherein conditioning the first signal further comprises retrieving the amplitude and phase data from the memory and applying the adjusted amplitude and phase associated with the retrieved amplitude and phase data to the first signal to form the second signal.

9. The method of claim 1, further comprising coupling the second signal to a second receiver.

10. A system for attenuating leakage power from a transmitter to a receiver, the system comprising:
a first input port configured to be coupled to the transmitter; and
a signal conditioning circuit having an input port configured to be coupled to the transmitter, and an output port configured to be coupled to an input of the receiver, the signal conditioning circuit configured to produce an anti-phase signal at the output port that attenuates a leakage signal coupled from the transmitter to the input of the receiver.

11. The system of claim 10, further comprising a directional coupler coupled to an antenna port of the transmitter, the directional coupler having an output port coupled to the first input port.

12. The system of claim 10, wherein the signal conditioning circuit is configured to adjust an amplitude and phase of a transmitter signal coupled to the first input port.

13. The system of claim 10, wherein the signal conditioning circuit comprises a tunable attenuator and a tunable phase shifter.

14. The system of claim 13, wherein the tunable attenuator comprises an adjustable resistor network.

15. The system of claim 14, wherein the adjustable resistor network comprises a PI network or a T network having resistors coupled in series with semiconductor switches.

16. The system of claim 13, wherein the tunable phase shifter comprises a PI network or a T network comprising an adjustable capacitor and an adjustable inductor.

17. The system of claim 16, wherein the adjustable capacitor comprises an accumulation mode MOSFET capacitor.

18. A radio frequency circuit comprising:
a transmitter configured to provide a transmission signal for a first system;
a first receiver configured to operate with a second system; and
a conditioning circuit coupled between the transmitter and the first receiver, the conditioning circuit configured to attenuate a leakage signal transmitted from the transmitter to the first receiver by producing an anti-phase signal and summing the anti-phase signal at an input of the first receiver.

19. The radio frequency circuit of claim 18, wherein the conditioning circuit comprises an adjustable attenuator and an adjustable phase shifter.

20. The radio frequency circuit of claim 19, wherein:
the adjustable attenuator comprises a resistive PI network or a resistive Tee network; and
the adjustable phase shifter comprises a LC PI network or a LC T network.

21. The radio frequency circuit of claim 19, wherein:
the adjustable attenuator comprises a plurality of switchable resistors; and
the adjustable phase shifter comprises a plurality of adjustable capacitors.

22. The radio frequency circuit of claim 18, wherein the conditioning circuit further comprises a directional coupler configured to be coupled to the transmitter.

23. The radio frequency circuit of claim 22, wherein the directional coupler is coupled to an antenna port of the transmitter.

24. The radio frequency circuit of claim 18, wherein:
the conditioning circuit further comprises a power detector coupled to a comparator; and
the conditioning circuit is further configured to sum the anti-phase signal at the input of the first receiver only when the comparator indicates that an output of the power detector exceeds a comparator threshold.

25. The radio frequency circuit of claim 18, further comprising a second receiver coupled to the first receiver, wherein the conditioning circuit is further configured to attenuate a further leakage signal transmitted from the transmitter to the second receiver by producing a further anti-phase signal and summing the further anti-phase signal at an input of the second receiver.

26. The radio frequency circuit of claim 25, wherein the transmitter is configured to transmit a GSM signal, the first receiver is configured to receive a FM signal, and the second receiver is configured to receive a USB signal.

27. The radio frequency circuit of claim 18, wherein the transmitter and the first receiver is disposed on a mobile phone.
